(19) United States
(12) Patent Application Publication
(10) Pub. No.: US 2026/0214024 A1
(43) Pub. Date: Jul. 23, 2026

(54) DATA NETWORK ADJUSTMENT USING ARTIFICIAL INTELLIGENCE

(71) Applicant: 1FINITY Inc., Kawasaki-shi (JP)

(72) Inventor: Solyman ASHRAFI, Plano, TX (US)

(73) Assignee: 1FINITY Inc., Kawasaki-shi (JP)

(21) Appl. No.: 19/415,496

(22) Filed: Dec. 10, 2025

Related U.S. Application Data
(60) Provisional application No. 63/747,032, filed on Jan. 19, 2025.

(51) Int. Cl. H04L 41/16; G06F 18/2321; H04W 24/02; H04W 24/08

(52) U.S. Cl. CPC H04L 41/16; G06F 18/2321; H04W 24/02; H04W 24/08

(57) ABSTRACT

A method may include obtaining information regarding an adjustment to a data network, the information being indicative of one or more parameters of the data network to adjust. The method may include selecting an artificial intelligence (AI) agent from multiple AI agents based on the one or more parameters. The method may also include determining an adjustment to the one or more parameters of the data network using the selected AI agent, the adjustment to the one or more parameters predicted by the selected AI agent to result in changes to the data network that conform with the information. The method may further include implementing the adjustment to the one or more parameters in the data network.

### FIELD

The present disclosure generally relates to data network adjustment using artificial intelligence.

### BACKGROUND

A data network may be used to provide secure, reliable, and high-performance data transmission between one or more devices and a core network. For example, a data network may facilitate the transmission of data using radio, optical, or electrical signals. A data network may be deployed in a variety of environments and may support connectivity between different types of devices and applications. For example, a data network may connect a phone to a mobile network over wireless, fiber optic, and/or wired infrastructure. As another example, a data network may provide a connection to access web-based resources, cloud applications, and/or other digital services.

The subject matter claimed in the present disclosure is not limited to embodiments that solve any disadvantages or that operate only in environments such as those described above. Rather, this background is only provided to illustrate example technology areas where some embodiments described in the present disclosure may be practiced.

### SUMMARY

In accordance with one or more embodiments of the present disclosure, a method may include obtaining information regarding an adjustment to a data network, the information being indicative of one or more parameters of the data network to adjust. An artificial intelligence (AI) agent may be selected from multiple AI agents based on the one or more parameters, each of the AI agents being trained to determine how to adjust a different set of parameters. The selected AI agent may be used to determine an adjustment to the one or more parameters of the data network, the adjustment to the one or more parameters being predicted by the selected AI agent to result in changes to the data network that conform with the information. The adjustment to the one or more parameters may be implemented in the data network.

The objects and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example environment for adjusting a data network using artificial intelligence;

FIG. 2 illustrates an example environment that includes a data network;

FIG. 3 illustrates an example multi-dimensional performance calculation for determining an adjustment of a data network;

FIG. 4 illustrates a flowchart of an example method of adjusting a data network using artificial intelligence; and

FIG. 5 is an example computing system, all in accordance with one or more embodiments of the present disclosure.

### DETAILED DESCRIPTION

A data network may be employed to transmit data between devices and/or a core network. In some circumstances, the data network may include a radio frequency network, an optical network, and/or an internet protocol network. Data networks may be used in various fields such as those involving emergency response systems, Internet of Things (IoT), manufacturing, logistics, healthcare, personal communication networks, and transportation. For example, a data network may be used to support autonomous vehicle communication systems that coordinate traffic flow and safety protocols between vehicles, infrastructure, and/or control centers, among other applications.

A data network may include many network parameters that may affect data transmission quality, network capacity, and/or service reliability, among other performance metrics. Such network parameters may impact how devices connect with and/or operate using the data network. For example, a data network may include network parameters that may indicate traffic volume, throughput, latency, signal strength, interference, quality of service, etc. Such network parameters may be adjusted to improve overall performance of the data network. In response to current values of network parameters not being adjusted for improved performance, end-user devices may experience undesired results such as disconnecting from the network (e.g., a dropped phone call), buffering, battery drain, etc.

As connected devices and data-intensive applications increase in popularity causing the demand on data networks to increase, changes to the current values of network parameters of data networks may occur with greater frequency. An automated process for measuring such changes efficiently and generating a set of corresponding network parameter adjustments to implement to improve performance of the data network may be helpful in keeping end-user devices connected with and operating using the data network as desired.

Traditional network parameter adjustment methods may rely on manual processes such as methods that involve trained personnel conducting field testing. Such traditional methods may be time-intensive and prone to error because of the large number of devices that may be included in a data network. For example, a data network may include two, five, ten, fifty, one hundred, a thousand, or thousands of network devices and even more end-user devices. Traditional methods may also be limited in their ability to simultaneously consider multiple interdependent network parameters. As data networks are increasingly employed by non-experts and include more devices, more network elements, and more protocols, automated network parameter adjusting may be increasingly useful.

The present disclosure may relate to, among other things, a method and system to adjust the network parameters of a data network using artificial intelligence (AI) agents. Thus, the network parameter adjusting process of the data network may be improved by creating a method and system of automating data network adjustments according to the present disclosure. Using the AI agents to automatically adjust network parameters in the data network based on current values of network parameters and information obtained indicative of one or more parameters to adjust may assist in ensuring that a data network is operating at a desired network performance level.

Embodiments of the present disclosure are explained with reference to the accompanying figures.

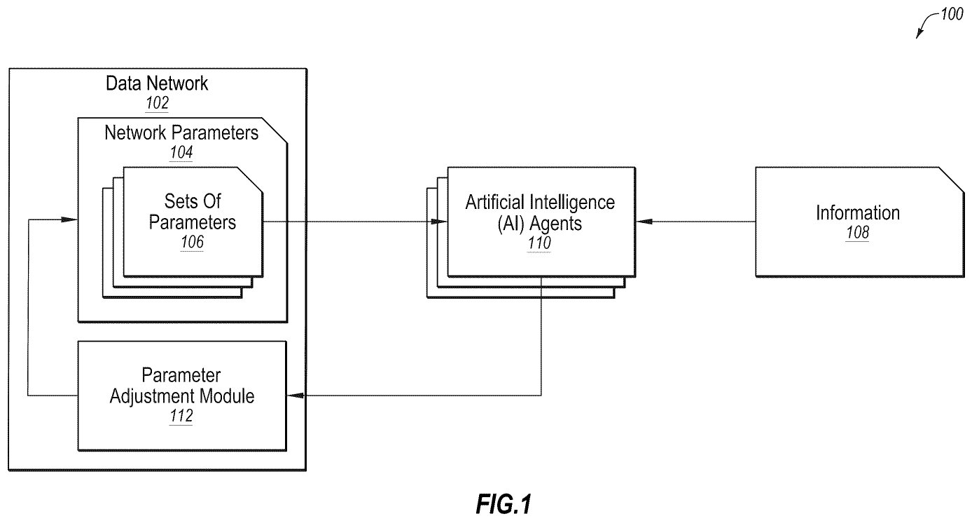

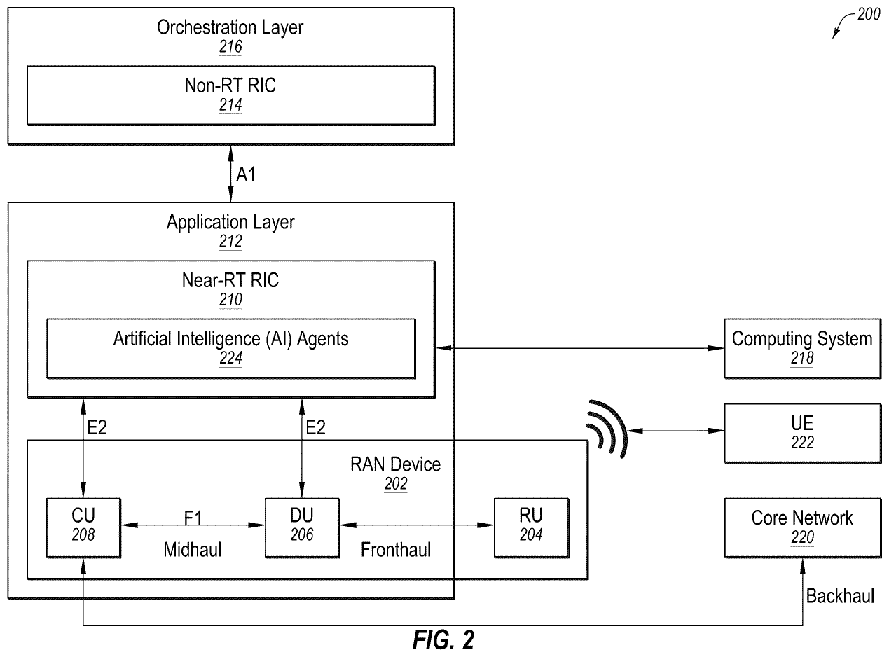

FIG. 1 illustrates an example environment 100 for adjusting network parameters 104 of a data network 102 using AI agents 110, in accordance with one or more embodiments of the present disclosure. In some embodiments, the data network 102 may include any network used to transmit data between devices and/or a core network. The data network 102 may be wireless network, an optical network, and/or a wired network, and may have numerous different configurations, including multiple different types of networks, network connections, and/or network protocols to communicatively couple devices and/or systems. For example, the data network 102 may include a radio frequency network, an optical network, and/or an internet protocol network. For instance, the data network 102 may include a radio access network (RAN) such as the data network 200 described below with respect to FIG. 2.

In some embodiments, the network parameters 104 may represent one or more measurements of the performance of the data network 102 (e.g., percentage of a geographic area covered by the data network 102, signal-to-noise ratio, handover success rate, etc.). Additionally or alternatively, the network parameters 104 may represent one or more settings or characteristics that may impact the performance of the data network 102 (e.g., resource allocation settings, security settings, modulation and coding scheme settings, etc.). For example, the network parameters 104 may include uplink power control, uplink scheduling, uplink resource allocation, uplink interference mitigation, uplink quality of experience, uplink performance spectral efficiency, energy consumption, processing efficiency, and/or any other parameter related to the performance of the data network 102.

In some embodiments, the network parameters 104 may be grouped into sets of parameters 106. In these and other embodiments, the sets of parameters 106 may be organized based on a known relationship between certain network parameters 104 (e.g., improved interference mitigation increases energy consumption) and/or based on user preference. For example, the network parameters 104 may be grouped into the sets of parameters 106 based on one or more key performance indicators (KPIs) (e.g., accessibility, retainability, mobility, integrity, availability, utilization, traffic, coverage, throughput, etc.) established by one or more users (e.g., a data network provider and/or data network industry members). In some embodiments, the known relationship between the network parameters 104 may be based on functional roles within the data network 102. For example, the network parameters 104 for a wireless network may be grouped accordingly into sets of parameters 106 such as transmission control parameters (e.g., power levels, timing offsets), resource scheduling parameters (e.g., allocation weights, priority settings), data flow management parameters (e.g., buffer sizes, throughput limits), interference mitigation parameters (e.g., filtering techniques, channel assignments), and quality of service (QoS) management parameters (e.g., user or application priority levels).

In some embodiments, one or more of the AI agents 110 may be configured to obtain information 108. In some embodiments, the information 108 may include any data, command, and/or user input corresponding to the data network 102. In these and other embodiments, the information 108 may relate to one or more of the network parameters 104 and may include an indication regarding an adjustment to the one or more of the network parameters 104. The adjustment to the one or more of the network parameters 104 may include an adjustment that results in improved performance of a network metric related to the one or more of the network parameters 104. For example, in a transmission control set of parameters, adjustment of power levels may result in improved signal quality and/or reduced interference between adjacent cells within the data network 102. For instance, the power level adjustment may include one or more modifications to uplink power control offsets that may increase the uplink power control by 2-3 decibels (dB), which may increase edge coverage of the data network 102 while maintaining acceptable interference levels.

In some embodiments, the information 108 may include an indication of an adjustment to be made to the network parameters 104, a general adjustment to the data network 102, and/or an indication of changes or potential changes to network conditions, such as network traffic conditions due to an event. For example, the information 108 may indicate specific network conditions or performance requirements that correspond to a particular parameter or particular set of parameters of the network parameters 104. For example, the information 108 stating that the data network 102 may be experiencing connectivity issues may be indicative of accessibility parameters. Similarly, the information 108 indicating concerns with data transmission quality may be indicative of integrity parameters such as downlink user throughput and uplink user throughput. In some embodiments, the information 108 may include target performance objectives and/or service level agreement requirements that certain network parameters affect.

In some embodiments, the information 108 may include one or more natural language inputs regarding a desired outcome in the data network 102. For example, a relatively new data network provider may prioritize throughput over capacity (e.g., in response to having a relatively few number of users) such that the information 108 may include a text prompt inputted by the data network provider to express an intent like: “increase user experience quality”, “do not focus on capacity”, “throughput is the number one focus for now”, “not a huge number of users yet, give them great quality”, and/or any other similar prompt. Additionally or alternatively to the information 108 being obtained through text prompts, the information 108 may be obtained through toggle selections, ranked lists, and/or any other form. In some embodiments, the information 108 may include direct instructions about one or more adjustments to the network parameters 104 (e.g., increase the modulation and coding scheme level). In these and other embodiments, the information 108 may be obtained using a graphical user interface.

In some embodiments, the AI agents 110 may be trained with respect to adjusting one or more of the sets of parameters 106. For example, one of the AI agents 110 may be trained with respect to adjusting one set of parameters, while another AI agent may be trained with respect to adjusting another set of parameters. In these and other embodiments, one of the AI agents 110 may be trained with respect to adjusting all the network parameters 104 (e.g., all the sets of network parameters 106).

In some embodiments, one or more of the AI agents 110 may be selected based on the information 108. The selection of the AI agents 110 may be based on the information 108 indicating specific parameters to be adjusted within the data network 102. For example, the selection process may identify one or more of the AI agents 110 that have been trained to handle the network parameters 104 indicated in the information 108. For example, when the information 108 indicates that accessibility parameters may be adjusted, an AI agent may be selected that has been trained to adjust accessibility-related parameters such as radio resource control setup success rate and voice over long-term evolution call setup success rate.

The selection process may involve analyzing the information 108 to determine which set of parameters 106 may be indicated to be adjusted by the information 108. For example, when the information 108 includes natural language inputs such as “improve user experience quality,” the AI agents 110 may identify that the information 108 corresponds to integrity parameters including downlink user throughput and uplink user throughput. As a result, an AI agent trained to adjust the integrity parameters of the data network 102 may be selected. In some embodiments, multiple AI agents 110 may be selected when the information 108 indicates that parameters from different sets of parameters 106 may require adjustment. In some embodiments, when the information 108 indicates adjustment of the entire data network 102, all the AI agents 110 may be selected.

In some embodiments, the selection process may include an AI agent analyzing the information 108 and selecting an appropriate AI agent to handle the specific requirements indicated by the information 108. For example, a master (e.g., orchestrator) AI agent may be configured to receive the information 108 and determine one or more of the AI agents 110 that may be suited to address the particular network conditions or performance requirements included, described, and/or suggested in the information 108. In some embodiments, the master AI agent may analyze the content of the information 108 and map such content to a training domain of one or more of the AI agents 110.

Additionally or alternatively, all the AI agents 110 may initially receive the information 108, and the AI agent that predicts that the information 108 may be most closely related to the set of parameters within the training domain of that AI agent may be selected. For example, an AI agent may evaluate the information 108 against the parameter set the AI agent was trained on and may generate a confidence score indicating how well the information 108 aligns with the area of expertise of the AI agent. The AI agent with the highest confidence score may be selected to handle determining the adjustment to the parameters 104 of the data network 102.

In some embodiments, the sets of parameters 106 may be obtained by the AI agents 110 via network interfaces. For example, for a radio frequency network with a near-real-time radio access network intelligence controller and a distributed unit, the AI agents 110 may be implemented on the near-real-time radio access network intelligence controller such that the AI agents 110 may obtain the sets of parameters 106 from the distributed unit via the E2 interface. In some embodiments, the sets of parameters 106 may each be obtained by an AI agent based on the network parameters 104 included in each set. For instance, an AI agent may be configured to obtain the set of parameters corresponding to the KPI of mobility such that the AI agent obtains the set of parameters that includes handover success rate, circuit switch fallback, and/or other network parameters 104 designated as corresponding to mobility. In some embodiments, only the selected AI agent may obtain sets of parameters 106. In these and other embodiments, the non-selected AI agents 110 may not obtain a set of parameters 106. In these and other embodiments, the set of parameters obtained by the selected AI agent may correspond to the parameters to be adjusted by the selected AI agent based on the information 108.

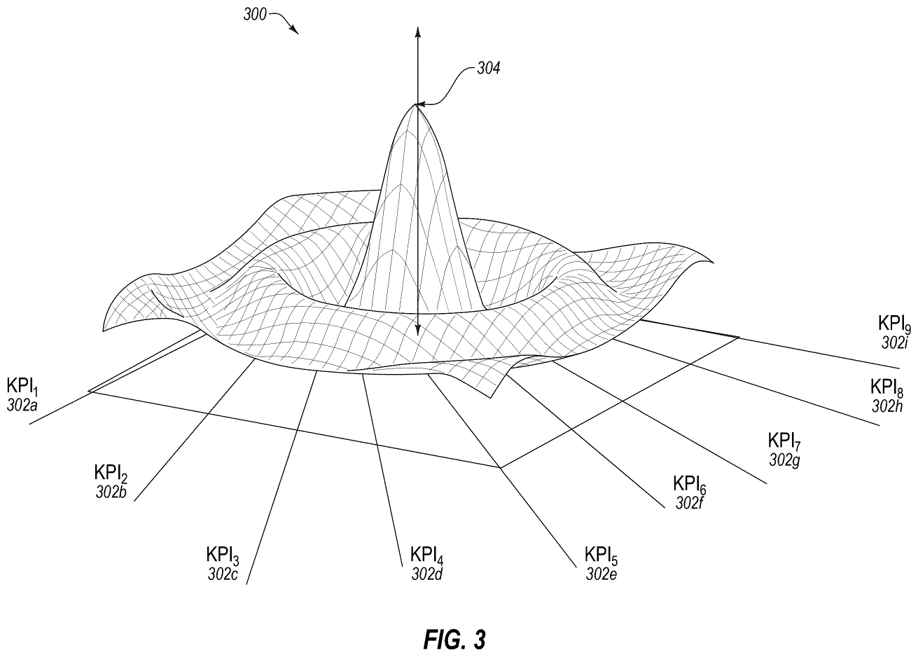

In some embodiments, each AI agent of the AI agents 110 may be configured to adjust the data network 102 by determining adjustments to the network parameters 104 corresponding to a KPI and/or to a set of the sets of parameters 106 that corresponds to the AI agents 110. For example, a first AI agent may be configured to adjust the data network 102 corresponding to accessibility parameters that relate to how end user devices initially connect to the data network 102. A second AI agent may be configured to increase performance corresponding to retainability parameters that influence connection stability and handoff success rates. In some embodiments, determining the adjustments to the network parameters 104 may include the AI agents 110 performing one or more multi-dimensional calculations such as the multi-dimensional calculation 300 described below with respect to FIG. 3.

In some embodiments, the selected AI agents 110 may be configured to determine the adjustment to the network parameters 104 using one or more machine learning models, the sets of parameters 106, and the information 108. In these and other embodiments, the models of the AI agents 110 and/or the AI agents 110 may be trained to determine the adjustment to the network parameters 104 to result in changes to the data network 102 that conform with the information 108. For example, the models may be trained to take the sets of parameters 106 as inputs and to determine adjustments to the sets of parameters 106 to increase and/or optimize a specified network KPI. The increase in the specified network KPI may be suggested or described in the information 108.

In some embodiments, the information 108 may indicate adjustment of the entire data network 102. In these and other embodiments, each of the AI agents 110 trained to adjust parts of the network (e.g., partial network AI agents 110) may determine adjustments to the network parameters 104 for which the AI agents 110 are trained. Each of the partial network AI agents 110 may send the adjustments to the AI agent trained for the entire data network 102 (e.g., the entire network AI agent or master AI agent), which may use the sets of parameters 106, the information 108, and the adjustments from the partial network AI agents 110 to determine adjustments for the entire data network 102 that may increase or optimize the overall performance of the data network 102.

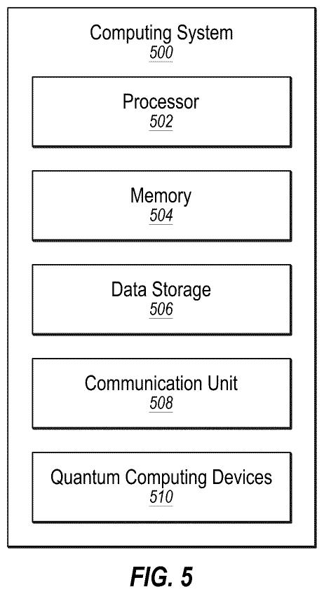

In some embodiments, the adjustments to the network parameters 104 determined by the AI agents 110 may be implemented in the data network 102 using a parameter adjustment module 112. The parameter adjustment module 112 may include code and routines configured to cause the implementation of the adjustments to the network parameters 104 in the data network 102. In some embodiments, the parameter adjustment module 112 may be implemented using hardware including one or more processors, central processing units, graphics processing units, data processing units, parallel processing units, microprocessors, field-programmable gate arrays, application-specific integrated circuits, accelerators, one or more programmable vision accelerators, which may include one or more vector processing units, one or more direct memory access systems, one or more pixel processing engines, and/or other processor types. In these and other embodiments, the parameter adjustment module 112 may be implemented using a combination of hardware and software. In some embodiments, operations described as being performed by the parameter adjustment module 112 may include operations that the parameter adjustment module 112 may direct one or more corresponding computing systems to perform. The parameter adjustment module 112 may be configured to perform a series of operations with respect to the network parameters 104 and/or the AI agents 110. In these and other embodiments, the parameter adjustment module 112 may be implemented by one or more computing systems, such as the computing system 500 described below with respect to FIG. 5.

In some embodiments, the environment 100 may increase the efficiency of adjusting the data network 102 compared to one or more traditional approaches to adjusting data networks. For example, a traditional approach may include a human operator manually evaluating current network performance, manually determining one or more objectives, manually adjusting the network parameters 104 in a trial-and-error manner, and then manually calculating impact the adjustment has on one or more KPIs. Such an approach may have difficulty in determining the adjustment and/or implementing the adjustment in the data network efficiently given that data networks may include many parameters with dynamic ranges. In contrast, the environment 100 may determine and implement an adjustment in the data network 102 efficiently.

In some embodiments, the models in the AI agents 110 may be trained by applying training data to one or more AI algorithms. For example, the AI agents 110 and/or the models may be trained using one or more reinforcement learning algorithms (e.g., Q-learning, state-action-reward-state-action, deep Q-network, advantage actor-critic, proximal policy optimization, trust region policy optimization, deep deterministic policy gradient, etc.). In some embodiments, the training of models in the AI agents 110 may include reinforcement learning using a reward model and a reinforcement learning policy model. The reward model may be configured to learn one or more behavior patterns that may be considered desirable based on feedback received based on network performance observations (e.g., from a user). In some embodiments, the reward model may be initialized using a pre-trained model corresponding to training on learning one or more preferences of system users. The reinforcement learning policy model may be trained by being guided by the reward model to determine one or more actions that the AI agents 110 may take to determine how to adjust the network parameters 104.

In some embodiments, during training and/or during inference, the reinforcement learning policy model may be trained to interact with the reward model to determine appropriate adjustments for the network parameters 104 in the data network 102. In these and other embodiments, the reinforcement learning policy model may receive state information corresponding to current network performance metrics and may generate action recommendations for adjusting one or more specific network parameters 104. In some embodiments, the reward model may evaluate the action recommendations and may provide one or more feedback signals that may guide the reinforcement learning policy model toward recommending actions that may result in improved network performance. In some embodiments, the reward model and the reinforcement learning policy model may interact iteratively until the reinforcement learning policy model may consistently determine parameter adjustments that achieve desired network performance objectives. Additionally or alternatively, the AI agents 110 may include and/or be configured to perform one or more parallelization algorithms and/or processing algorithms.

In some embodiments, training the models may include a supervised learning process. In some embodiments, the supervised learning process may involve a data network engineer determining ground truth based on adjustments made to a network to achieve a desired result. The data network engineer may observe the current network performance metrics and may implement specific parameter adjustments to address performance issues or to meet target objectives. The engineer may document the relationship between the initial network state, the implemented adjustments, and the resulting network performance outcomes. The documented relationship may serve as ground truth data for training the AI agents 110. The ground truth may represent a parameter adjustments for specific network conditions and performance requirements. The AI agents 110 may be trained to replicate the adjustments by learning from the documented examples of successful network adjustments. The supervised learning process may continue until the AI agents 110 may consistently predict parameter adjustments that align with the ground truth established by the data network engineer's documented decisions. Alternately or additionally, quantum annealing and/or simulated annealing may be used to determine the ground truth data for training the AI agents 110.

Additionally or alternatively, training the models may include an unsupervised learning process. In some embodiments, the unsupervised learning process may involve the AI agents 110 learning network parameter optimization patterns without explicit human supervision or labeled training data. The unsupervised learning algorithms may analyze network performance data to identify underlying relationships between network parameters 104 and performance outcomes. The AI agents 110 may employ clustering algorithms to group similar network states and may use dimensionality reduction techniques to identify the most significant parameters affecting network performance. In some embodiments, a quantum computer may be configured to perform quantum annealing to determine parameter configurations. The quantum annealing process may involve mapping the network optimization problem to a quantum Hamiltonian and may allow the quantum system to evolve toward the ground state that represents a solution. Additionally or alternatively, quantum-inspired hardware may be configured to perform simulated annealing to approximate quantum annealing behavior using classical computing resources.

In some embodiments, the training process may utilize an objective function to guide the learning of the AI agents 110 toward determining appropriate network parameter adjustments. The objective function may be defined as a mathematical expression that quantifies the difference between the AI agents'110 predictions and the desired network performance outcomes, serving as a measure of how well the AI agents 110 are learning to adjust network parameters according to specified performance criteria. In some embodiments, the objective function may include a loss function, a cross-entropy loss function for training reward models in reinforcement learning scenarios, or a mean squared error function for regression-based parameter optimization tasks, among other functions.

For example, an objective function used during the training of the AI agents 110 may be configured to determine the differences between a first distribution of network performance metrics and the second distribution of network performance metrics. In these and other embodiments, the first distribution of network performance metrics may be based on a ground truth, such as a distribution of network performance metrics as determined by a network engineer or by calculating an adjustment. The second distribution of network performance metrics may be based on a calculated network performance metric, such as a distribution of network performance metrics as determined by an AI agent during training of the AI agent. The distribution of network performance metrics may be calculated by applying statistical analysis techniques to collected network telemetry data and determining probability density functions that characterize the current network state across multiple performance dimensions.

In some embodiments, the objective function may determine a divergence between a probability density of the first distribution of network performance metrics and a probability density of the second distribution of network performance metrics. For example, the objective function may calculate the divergence by calculating a Kullback-Leibler divergence (e.g., cross-entropy). In some embodiments, training the models may include determining one or more adjustments to the network parameters 104 that may reduce the differences between a probability density of a first distribution of network performance metrics and a probability density of a second distribution of network performance metrics (e.g., minimize the divergence). In these and other embodiments, the objective function may thus not merely seek to minimize a difference between parameters values but may seek to minimize divergence between probability densities of the distribution of network performance metrics.

In some embodiments, the AI agents 110 may utilize hardware components such as a central processing unit, a graphics processing unit; software applications configured to perform stochastic gradient descents, conformal geometric algebra, Clifford algebra; and/or a combination of hardware and software. In these and other embodiments, such hardware and/or software may increase the computational efficiency, scalability, and robustness of algoirthms performed by the AI agents 110.

Modifications, additions, or omissions may be made to the environment 100 without departing from the scope of the present disclosure. For example, in some embodiments, the environment 100 may include any number of other components that may not be explicitly illustrated or described.

FIG. 2 illustrates an example environment that includes a data network 200 configured for parameter adjustment by AI agents 224, in accordance with one or more embodiments of the present disclosure. In some embodiments, the data network 200 may include a radio access network (RAN) device 202, which may include a radio unit 204 (RU 204), a distributed unit 206 (DU 206), and/or a central unit 208 (CU 208). In these and other embodiments, the data network 200 may include a near-real-time radio access network intelligent controller 210 (near-RT RIC 210) and/or a non-real-time radio access network intelligent controller 214 (non-RT RIC 214). Additionally or alternatively, data network 200 may include and/or be communicatively coupled to a computing system 218, a core network 220, and/or user equipment 222 (UE 222).

In some embodiments, the RAN device 202 may include any device in which radio broadcast operations may be performed. For example, the RAN device 202 may be a device that includes hardware and/or software configured to generate a RAN using radio frequency signals. For example, the RAN device 202 may include one or more antennas, transceivers, amplifiers, filters, converters, interfaces, and other hardware and software configured to configured to implement and/or manage one or more RAN protocols. For instance, the RAN device 202 may include a base transceiver station, a small cell, a distributed antenna system, a baseband unit, or one or more components thereof.

In some embodiments, the RAN device 202 may include one or more virtualized components. For example, the RAN device 202 may include a physical RU 204 (e.g., a remote radio head) while having the DU 206 and/or the CU 208 configured to implement functions using virtualized infrastructure (e.g., one or more cloud servers or edge servers) within a virtualized RAN (VRAN) architecture. In some embodiments, the RU 204 may be located relatively near or integrated with a radio antenna and may be configured to transmit, receive, and/or amplify radio frequency signals. In some embodiments, the RU 204 may communicate with the DU 206 via a fronthaul interface. In these and other embodiments, the fronthaul interface may include any type of network, such as an optical or a wireless network, configured to enable interoperability and/or virtualization between the RU 204 and the DU 206.

In some embodiments, the RAN device 202 may be configured to establish a RAN. In these and other embodiments, establishing a RAN may include the RAN device 202 being configured to wirelessly interface with other devices and connect the devices to one or more other networks, such as public or private networks.

In some embodiments, the DU 206 may be configured to run lower layers of the RAN's protocol stack including the upper physical layer, the radio link control layer, and/or the medium access control layer. In some embodiments, the DU 206 and the CU 208 may be communicatively coupled via a network interface (e.g., the F1 interface or midhaul interface). In these and other embodiments, the DU 206 may be controlled by the CU 208. For example, the CU 208 may enforce network policies such as quality of service policies governing the behavior of the DU 206. In some embodiments, the CU 208 may be configured to run higher layers of the RAN's protocol stack including the radio resource control layer such that the CU 208 may be configured to adjust parameters of the DU 206 related to transmission power, modulation and coding scheme, handover, load balancing, etc. In these and other embodiments, the CU 208 may control the DU 206 as part of coordinating operations performed by multiple DUs. In these and other embodiments, the CU 208 may be located at or relatively near a base station or may be located at a central aggregation site for multiple DUs.

In some embodiments, the near-RT RIC 210 may be a virtualized component of the RAN. In some embodiments, the near-RT RIC 210 may be configured to perform resource management operations of the RAN in near-real-time (e.g., in less than one second). For example, the near-RT RIC 210 may perform resource management operations in 10 milliseconds, 100 milliseconds, 500 milliseconds, 900 milliseconds, etc., up to one second. In some embodiments, the resource management operations performed by the near-RT RIC 210 may be executed using an application (e.g., an eXtended application (xApp)). In these and other embodiments, the near-RT RIC 210 may be configured to host one or more of the AI agents 224. For example, the AI agents 224 may be executed using an xApp of the near-RT RIC 210.

In these and other embodiments, the near-RT RIC 210 may interact with the RAN device 202 by receiving data from and sending instructions and/or data to one or more components of the RAN device 202. For example, the near-RT RIC 210 may obtain current values of one or more network parameters from the RAN device 202. In some embodiments, the current values may be the measurements and/or determinations of the network parameters for a given timeframe (e.g., since the last time measurements were taken). In some embodiments, the near-RT RIC 210 may obtain the current values of one or more network parameters via the DU 206 of the RAN device 202.

In some embodiments, one or more of the AI agents 224 hosted on the near-RT RIC 210 may determine the adjustment for the network parameters of the data network 200 based on the current values of the network parameters and/or on information (e.g., an intention specified by a user as described with respect to FIG. 1). In these and other embodiments, the adjustment may be configured to adjust, such as improve, one or more KPI's of the data network 200. Additionally or alternatively, the adjustment may be configured to adjust, such as improve, overall network performance of the data network. In some embodiments, the near-RT RIC 210 may provide the current values of the network parameters to the AI agents 224 such that one or more of the AI agents 224 may determine the adjustment to the network parameters.

In some embodiments, one or more of the AI agents 224 may be configured to determine the adjustment to the one or more network parameters based on the current values of the network parameters and the one or more AI models.

In some embodiments, the AI agents 224 and/or the near-RT RIC 210 may be communicatively coupled to the computing system 218. In these and other embodiments, the computing system 218 may be used in addition to the AI agents 224 and/or at the direction of the AI agents 224 to help to determine the adjustment to the network parameters. In some embodiments, the computing system 218 may include one or more computing systems, such as multiple servers that each include memory and at least one processor. Additionally or alternatively, the computing system 218 may be a system configured to perform one or more of quantum annealing or simulated annealing (e.g., a quantum computer, a digital annealer, a noisy intermediate-scale quantum (NISQ) device, etc.) such as the computing system 500 described below with respect to FIG. 5.

For example, the computing system 218 may be configured to supplement or replace computational functions performed by the AI models within the AI agents 224 when determining adjustments to network parameters. In some embodiments, the computing system 218 may include specialized hardware components such as quantum computers, digital annealers, or noisy intermediate-scale quantum (NISQ) devices that may be particularly suited for adjustment calculations. In these and other embodiments, the computing system 218 may be utilized when the AI agents 224 encounter computationally intensive optimization problems that may benefit from specialized processing capabilities. The computing system 218 may receive current network parameter values and objectives from the AI agents 224 and may return calculated parameter adjustments.

In some embodiments, the data network 200 may include a non-RT RIC 214 configured to operate on an orchestration layer 216. In some embodiments, the orchestration layer 216 may include a management and network orchestration framework and/or an open network automation platform such that the non-RT RIC 214 may perform network management resource operations that take greater than 1 second to perform. For example, the non-RT RIC 214 may manage the configuration, architecture, and/or infrastructure of the data network 200 by facilitating communication between the orchestration layer 216 and the application layer 212 (e.g., via an A1 interface) and/or between the orchestration layer 216 and the RU 204, DU 206, and/or CU 208 (e.g., via an O1 interface). In some embodiments, the AI agents 224 may be hosted on the non-RT RIC 214.

In some embodiments, the core network 220 may be any network or configuration of networks configured to send and receive communications between systems and devices. In some embodiments, the core network 220 may include a wired network, an optical network, and/or a wireless network, and may have numerous different configurations, including multiple different types of networks, network connections, and/or network protocols to communicatively couple devices and systems in the data network 200. In some embodiments, the RAN device 202 may connect to the core network 220 via the CU 208. In these and other embodiments, the CU 208 may communicate with the core network 220 via a backhaul interface. The backhaul interface may include any type of network, such as an optical or a wireless network, configured to connect the core network 220 with one or more subnetworks operated by the CU 208. For example, the CU 208 of the RAN device 202 may connect to the core network 220 using the backhaul interface to exchange data between the UE 222 and the Internet, update firmware, receive provisioning-related data, communicate with a spectrum access system, etc.

In some embodiments, the UE 222 may be any electronic device that is configured for wireless communication. For example, the UE 222 may be a mobile phone, smart phone, laptop, computer, desktop computer, vehicle, and/or any other device configured to receive data transmitted by the data network 200. In some embodiments, the UE 222 may use the data network 200 to perform a user task (e.g., make a phone call, stream a video, perform a search on the Internet, etc.) by remotely connecting to the core network 220 via the RAN device 202. For example, the UE 222 may transmit radio signals to the RU 204 to be digitized that the radio signals may be sent between the RU 204 and the DU 206, between the DU 206 and the CU 208, and between the CU 208 and the core network 220 to establish a connection between the UE 222 and the core network 220.

As an example, the RAN device 202 may be configured to establish the data network 200 as a radio frequency network. The RAN device 202 may include at least one RU 204 configured to transmit and/or receive radio signals to and/or from at least one UE 222. Based on demand from the at least one UE 222, network parameters of the data network 200 established by the RAN device 202 may change. For instance, many simultaneous mobile phone users (e.g., in response to an emergency situation, at a parade, at a sporting event, at a concert, on a particular date such as Mother's Day, etc.) may impact network parameters of the data network 200 such as by increasing download/upload times, etc. The DU 206 may be configured to determine current values of the network parameters. For example, the DU 206 may be communicatively coupled to the at least one RU 204 such that the DU 206 may aggregate data of network parameters to determine current values of the network parameters that are representative of the overall network performance of the data network 200. The DU 206 may be configured to send the current values of the network parameters to the AI agents 224 hosted on the near-RT RIC 210, such as through a network interface (e.g., the E2 interface). In response to receiving the current values of the network parameters, an AI agent of the AI agents 224 may be selected based on the current values of the network parameters and/or information obtained regarding an adjustment to the data network 200 indicative of the network parameters to adjust. The selected AI agent may be configured to determine the adjustment to the network parameters. In response to obtaining the adjustment, the near-RT RIC 210 may direct the adjustment to the DU 206 for implementation in near-real-time in the data network 200. For instance, the DU 206 may direct the RU 204 and/or other components of the RAN device 202 to adjust one or more settings (e.g., adjust the radio frequency the RU 204 is transmitting at, adjust the modulation and coding schemes, etc.).

In some embodiments, adjusting the data network 200 using the AI agents 224 may increase the speed in which implementation of desired network performance metrics may be achieved while maintaining network stability during the adjustment process.

Modifications, additions, or omissions may be made to the data network 200 without departing from the scope of the present disclosure. For example, in some embodiments, the data network 200 may include any number of other devices, systems, and/or components that may not be explicitly illustrated or described. Further, the data network 200 may be implemented within other systems or contexts than those described.

FIG. 3 is an example multi-dimensional calculation 300 for determining an adjustment of network parameters to achieve intended data network performance 304 using KPIs 302a-302i, in accordance with one or more embodiments of the present disclosure. In some embodiments, the multi-dimensional calculation 300 may include solving for or estimating one or more solutions to an optimization problem.

The intended network performance 304 may be calculated based on grouping the network parameters into sets of parameters based on KPIs. For example, each of the KPIs 302a-302i may be represented in the multi-dimensional calculation 300 as existing in a separate plane (e.g., dimension) such that the multi-dimensional calculation 300 may represent relationships between the KPIs 302a-302i and/or between the network parameters included in the KPIs 302a-302i.

In some embodiments, network parameter adjustments may be generated based on the intended network performance 304 determined by the multi-dimensional calculation 300 using the KPIs 302a-302i. For example, the multi-dimensional calculation 300 may be performed by one or more AI agents such as the AI agents 110 described above with respect to FIG. 1 and/or the AI agents 224 described above with respect to FIG. 2. In some embodiments, the AI agents may be used to determine (e.g., solve or estimate) how adjusting certain network parameters may impact on or more of the KPIs 302a-302i and/or the overall network performance of the data network. In some embodiments, a same network parameter may be included in multiple of the KPIs 302a-302i. For example, energy consumption may be a network parameter accounted for in an accessibility KPI as well as in an integrity KPI. In some embodiments, adjusting one network parameter may adjust multiple KPIs and/or overall performance of the data network.

In some embodiments, the intended network performance 304 may indicate an overall performance of the data network that satisfies an overall network threshold even when one or more, or all, of the KPIs 302a-302i may not be configured to satisfy a desired individual KPI threshold. For example, returning to the scenario where a user may indicate an intention to prioritize throughput, the intended network performance 304 may indicate the overall performance of the data network in response to adjusting the network parameters to increase throughput.

In some embodiments, the adjustment to the network parameters determined using the multi-dimensional calculation 300 (e.g., by one or more AI agents) may be implemented in the data network (e.g., via a parameter adjustment module such as the parameter adjustment module 112 described above with respect to FIG. 1 or a DU such as the DU 206 described above with respect to FIG. 2).

Modifications, additions, or omissions may be made to the multi-dimensional calculation 300 without departing from the scope of the present disclosure. For example, in some embodiments, the multi-dimensional calculation 300 may include any number of other dimensions, KPIs, graphical representations, etc. that may not be explicitly illustrated or described.

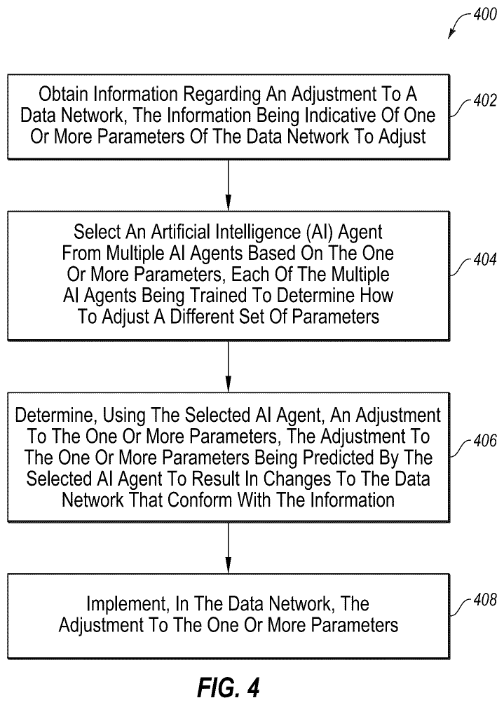

FIG. 4 is a flowchart of an example method 400 of adjusting parameters of a data network using AI agents, in accordance with one or more embodiments of the present disclosure. The method 400 may be performed by any suitable system, apparatus, or device. For example, the method 400 may be implemented by one or more systems and/or devices described above with respect to FIGS. 1 and 2. Additionally or alternatively, one or more operations of the method 400 may be performed by a computing system, such as the computing system 500 described below with respect to FIG. 5. Although illustrated with discrete blocks, the steps and operations associated with one or more blocks of the method 400 may be divided into additional blocks, combined into fewer blocks, or eliminated, depending on the particular implementation. In some embodiments, one or more non-transitory computer readable mediums may be configured to store instructions that when executed result in performing the method 400.

The method 400 may include block 402. At block 402, information regarding an adjustment to a data network may be obtained. The data network may be the same as or similar to the data network 102 described above with respect to FIG. 1, and the information may be the same as or similar to the information 108 described above with respect to FIG. 1. In some embodiments, the information regarding the adjustment may be indicative of one or more parameters of the data network to adjust. For example, the information may include one or more direct or indirect instructions, prompts, and/or commands to change performance of the data network in some specified manner. For instance, the information may indicate that parameters corresponding to retainability as a KPI are to be adjusted so as to increase retainability in the overall data network. In some embodiments, obtaining the information regarding the adjustment to the data network may be performed by one or more AI agents.

The method 400 may include block 404. At block 404, an AI agent may be selected from multiple AI agents based on the one or more parameters. The multiple AI agents may be the same as or similar to the AI agents 110 described above with respect to FIG. 1 and/or the AI agents 224 described above with respect to FIG. 2. In some embodiments, each of the AI agents may be trained to determine how to adjust a different set of parameters (e.g., accessibility parameters, retainability parameters, mobility parameters, integrity parameters, etc.) from multiple sets of parameters. In these and other embodiments, the sets of parameters may be the same as or similar to the sets of parameters 106 described above with respect to FIG. 1. For example, the sets of parameters may correspond to KPIs. In some embodiments, selecting the AI agent may include analyzing the sets of parameters to determine which AI agent may possess appropriate training to perform one or more parameter adjustment calculations and/or predictions. In some embodiments, each of the AI agents may be trained using reinforcement learning algorithms that may use an objective function based on differences between a first distribution of network performance metrics associated with ground truth network performance metrics and a second distribution of network performance metrics associated with calculated network performance metrics. In some embodiments, one of the AI agents may be a master AI agent configured to orchestrate between the AI agents. In these and other embodiments, the master AI agent may be configured to receive the information and orchestrate between the AI agents to determine the AI agent to be selected (e.g., by analyzing the content of the information and mapping such content to the training domains of the AI agents). In some embodiments, the AI agents (e.g., the master AI agent and/or the other AI agents) may be configured on a near-RT RIC on an application layer of a data network and orchestration may be facilitated by the application layer being in communication via an AI interface with an orchestration layer of the data network. Additionally or alternatively, one or more of the AI agents may be configured on the orchestration layer of the data network (e.g., on a non-RT RIC).

The method 400 may include block 406. At block 406, the selected AI agent may be used to determine an adjustment to the one or more parameters of the data network. In some embodiments, the adjustment to the one or more parameters may be predicted by the selected AI agent to result in changes to the data network that conform with the information. For example, determining the adjustment may include performing a multi-dimensional calculation that may be the same as or similar to the multi-dimensional calculation 300 described above with respect to FIG. 3.

The method 400 may include block 408. At block 408, the adjustment to the one or more parameters may be implemented in the data network. In some embodiments, implementing the adjustment may include communicating the adjustment to one or more data network components configured to implement parameter adjustments. For example, the adjustment may be implemented by a parameter adjustment module that may be the same as or similar to the parameter adjustment module 112 described above with respect to FIG. 1. Additionally or alternatively, the adjustment may be implemented by a DU that may be the same as or similar to the DU 206 described above with respect to FIG. 2.

Modifications, additions, or omissions may be made to the method 400 without departing from the scope of the present disclosure. For example, the outlined steps and operations are only provided as examples, and some of the steps and operations may be optional, combined into fewer steps and operations, or expanded into additional steps and operations without detracting from the essence of the disclosed embodiments.

For example, in some embodiments, the data network in the method 400 may include a radio frequency network, an optical network, and/or an internet protocol network. In these and other embodiments, the radio frequency network may include a near-RT RIC, and in some embodiments, the AI agents may be implemented on the near-RT RIC.

FIG. 5 illustrates an example computing system 500, in accordance with one or more embodiments of the present disclosure. The computing system 500 may include a processor 502, a memory 504, a data storage 506, a communication unit 508, and/or a quantum computing device 510, which all or one or more of may be communicatively coupled. In some embodiments, data network 102, the AI agents 110, and/or the parameter adjustment module 112 described above with respect to FIG. 1 and/or the RAN device 202, the RU 204, the DU 206, the CU 208, the near-RT RIC 210, the non-RT RIC 214, the computing system 218, the UE 222, and/or the AI agents 224 described above with respect to FIG. 2 may be implemented as or configured to utilize a computing system such as the computing system 500 or parts thereof.

Generally, the processor 502 may include any suitable special-purpose or general-purpose computer, computing entity, or processing device including various computer hardware or software modules and may be configured to execute instructions stored on any applicable computer-readable storage media. For example, the processor 502 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 5, the processor 502 may include any number of processors distributed across any number of network or physical locations that are configured to perform individually or collectively any number of operations described in the present disclosure. In some embodiments, the processor 502 may interpret and/or execute program instructions and/or process data stored in the memory 504 and/or in the data storage 506. In some embodiments, the processor 502 may fetch program instructions from the data storage 506 and load the program instructions into the memory 504.

After the program instructions are loaded into the memory 504, the processor 502 may execute the program instructions, such as instructions to cause the computing system 500 to perform one or more of the operations of the method 400 described above with respect to FIG. 4. For example, the computing system 500 may execute the program instructions to obtain the information regarding the adjustment to the data network at block 402, to select the AI agent based on the one or more parameters at block 404, to determine the adjustment to the one or more parameters using the selected AI agent at block 406, and/or to implement the adjustment to the one or more parameters in the data network at block 408.

The memory 504 and the data storage 506 may include computer-readable storage media or one or more computer-readable storage mediums for having computer-executable instructions or data structures stored thereon. Such computer-readable storage media may be any available media that may be accessed by a general-purpose or special-purpose computer, such as the processor 502. In some embodiments, the computing system 500 may or may not include either of the memory 504 and the data storage 506.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 502 to perform a particular operation or group of operations.

The communication unit 508 may include any component, device, system, or combination thereof that is configured to transmit or receive information over a network. In some embodiments, the communication unit 508 may communicate with other devices at other locations, the same location, or even other components within the same system. For example, the communication unit 508 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 508 may permit data to be exchanged with a network and/or any other devices or systems described in the present disclosure. For example, the communication unit 508 may allow the computing system 500 to communicate with other systems, such as computing devices and/or other networks.

In some embodiments, the computing system 500 may include a quantum computing device 510 that may receive instructions from and/or send data to the processor 502. For example, the quantum computing device 510 may include a noisy intermediate-scale quantum (NISQ) device, a quantum annealer, an analog quantum computer, a universal quantum computer, and/or any other computing device or combination of computing devices with at least one quantum bit (qubit). In these and other embodiments, the quantum computing device 510 may include at least one quantum processor, which may include at least one qubit. The at least one qubit may be physically implemented using, for example, photons, trapped ions, electrons, one or more nuclei, superconductor circuits, and/or quantum dots. A qubit may be physically implemented in a variety of ways including the polarization state of a single photon, the spatial optical path of a single photon, two differing energy states of an atom or an ion, and/or the spin orientation of a particle or multiple particles, such as a nucleus. In some embodiments, the quantum computing device 510 may include one or more computing devices with at least two qubits and at least one coupler capable of coupling the qubits. Storing the at least one qubit may include maintaining the at least one qubit in a suitable environment to allow quantum computation, for example by supercooling the at least one qubit. The at least one qubit may be operated upon by one or more quantum circuits, formed by a suitable arrangement of quantum logic gates.

In some embodiments, the quantum computing device 510 may include one or more computing devices configured to perform quantum annealing and/or simulated annealing (e.g., quantum-inspired simulated annealing). Additionally or alternatively, the quantum computing device 510 may be configured to approximate solutions to and/or solve combinatorial optimization problems formulated as quadratic unconstrained binary optimization (QUBO) problems.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method, comprising:
obtaining information regarding an adjustment to a data network, the information being indicative of one or more parameters of a plurality of parameters of the data network to adjust;
selecting an artificial intelligence (AI) agent from a plurality of AI agents based on the one or more parameters, each of the plurality of AI agents trained to determine how to adjust a different set of parameters of the plurality of parameters of the data network;
determining, using the selected AI agent, an adjustment to the one or more parameters of the data network, the adjustment to the one or more parameters predicted by the selected AI agent to result in changes to the data network that conform with the information; and
implementing, in the data network, the adjustment to the one or more parameters.

2. The method of claim 1, wherein the data network includes a radio frequency network, an optical network, or an internet protocol network.

3. The method of claim 2, wherein the radio frequency network includes a near-real time radio access network intelligent controller and a distributed unit.

4. The method of claim 3, wherein the plurality of AI agents are implemented on the near-real time radio access network intelligent controller.

5. The method of claim 1, wherein each of the plurality of AI agents are trained using reinforcement learning algorithms that utilize an objective function that is based on differences between a first distribution of network performance metrics associated with ground truth network performance metrics and a second distribution of network performance metrics associated with calculated network performance metrics.

6. The method of claim 5, wherein determining the differences includes calculating a divergence between a probability density of the first distribution of network performance metrics and a probability density of the second distribution of network performance metrics.

7. The method of claim 6, wherein quantum annealing or simulated annealing are used to determine the probability density of the second distribution of network performance metrics.

8. A system, comprising:
one or more non-transitory computer readable media configured to store instructions; and
one or more processors coupled to the one or more non-transitory computer readable media and configured to execute the instructions to perform operations, the operations comprising:
obtain information regarding an adjustment to a data network, the information being indicative of one or more parameters of a plurality of parameters of the data network to adjust,
select an artificial intelligence (AI) agent from a plurality of AI agents based on the one or more parameters, each of the plurality of AI agents trained to determine how to adjust a different set of parameters of the plurality of parameters,
determine, using the selected AI agent, an adjustment to the one or more parameters, the adjustment to the one or more parameters predicted by the selected AI agent to result in changes to the data network that conform with the information, and
implement, in the data network, the adjustment to the one or more parameters.

9. The system of claim 8, wherein the data network includes one or more of a radio frequency network, an optical network, and an internet protocol network.

10. The system of claim 9, wherein the radio frequency network includes a near-real time radio access network intelligent controller and a distributed unit.

11. The system of claim 10, wherein the plurality of AI agents are implemented on the near-real time radio access network intelligent controller.

12. The system of claim 8, wherein each of the plurality of AI agents are trained using reinforcement learning algorithms that utilize an objective function that is based on differences between a first distribution of network performance metrics associated with ground truth network performance metrics and a second distribution of network performance metrics associated with calculated network performance metrics.

13. The system of claim 12, wherein determining the differences includes calculating a divergence between a probability density of the first distribution of network performance metrics and a probability density of the second distribution of network performance metrics.

14. The system of claim 13, wherein quantum annealing or simulated annealing are used to determine the probability density of the second distribution of network performance metrics.

15. One or more non-transitory computer-readable media storing instructions that, when executed by one or more processors, cause a system to perform operations, the operations comprising:
obtaining information regarding an adjustment to a data network, the information being indicative of one or more parameters of a plurality of parameters of the data network to adjust;
selecting an artificial intelligence (AI) agent from a plurality of AI agents based on the one or more parameters, each of the plurality of AI agents trained to determine how to adjust a different set of parameters of the plurality of parameters of the data network;
determining, using the selected AI agent, an adjustment to the one or more parameters of the data network, the adjustment to the one or more parameters predicted by the selected AI agent to result in changes to the data network that conform with the information; and
implementing, in the data network, the adjustment to the one or more parameters.

16. The one or more non-transitory computer-readable media of claim 15, wherein the data network includes a radio frequency network, an optical network, or an internet protocol network.

17. The one or more non-transitory computer-readable media of claim 16, wherein the radio frequency network includes a near-real time radio access network intelligent controller and a distributed unit, and wherein the plurality of AI agents are implemented on the near-real time radio access network intelligent controller.

18. The one or more non-transitory computer-readable media of claim 15, wherein each of the plurality of AI agents are trained using reinforcement learning algorithms that utilize an objective function that is based on differences between a first distribution of network performance metrics associated with ground truth network performance metrics and a second distribution of network performance metrics associated with calculated network performance metrics.

19. The one or more non-transitory computer-readable media of claim 18, wherein determining the differences includes calculating a divergence between a probability density of the first distribution of network performance metrics and a probability density of the second distribution of network performance metrics.

20. The one or more non-transitory computer-readable media of claim 19, wherein quantum annealing or simulated annealing are used to determine the probability density of the second distribution of network performance metrics.
